(19) United States
(12) Patent Application Publication
(10) Pub. No.: US 2015/0366259 A1
(43) Pub. Date: Dec. 24, 2015

(54) METHOD AND A SYSTEM FOR JUICE PRESERVATION

(71) Applicant: Rebecca L. Perkins, Beaumont, CA (US)

(72) Inventor: Rebecca L. Perkins, Beaumont, CA (US)

(21) Appl. No.: 14/311,316

(22) Filed: Jun. 22, 2014

(51) Int. Cl. A23L 3/36; A23N 1/02; A23L 2/12

(52) U.S. Cl. CPC A23L 3/364; A23L 2/12; A23N 1/02; A23V 2002/00

(57) ABSTRACT

A method and a system comprise extracting a juice from an editable food material using a juice processor. The extracted juice is dispensed into a container having a volume. The volume is at a cryogenic temperature wherein the dispensed extracted juice generally forms a plurality of beads at the cryogenic temperature. The plurality of beads are stored to have a longer shelf life than non-frozen extracted juice and nutritional degradation is mitigated.

### CROSS-REFERENCE TO RELATED APPLICATIONS

Not applicable.

### RELATED CO-PENDING U.S. PATENT APPLICATIONS

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to a juice preservation system and method. More particularly, the invention relates to a juice preservation system and method that cryogenically freezes fresh juice to increase shelf life and inhibit nutritional degradation.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that cryogenics involves materials that have very low temperatures (below −150° C., −238° F. or 123 K).

Typically, liquid nitrogen is a cryogenic liquid. Liquid nitrogen can maintain temperatures far below the freezing point of water makes it extremely useful in a wide range of applications. Freezing edible items is known in the art with liquid nitrogen.

Often, juice is a liquid that is naturally contained in fruit and vegetables. A juicer can separate the flesh from the pulp in the fruit or vegetable to produce the liquid juice. Juice is commonly consumed as a beverage or used as an ingredient or flavoring in foods. Popular juices include, orange juice, apple juice, grape juice, and carrot juice.

It is known that juice is prepared by mechanically squeezing or macerating fruit or vegetable flesh without the application of heat or solvents. For example, orange juice is the liquid extract of the fruit of the orange tree, and tomato juice is the liquid that results from pressing the fruit of the tomato plant. Juices have a limited shelf life since the vitamins and nutrients can degrade quickly.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a block diagram of an exemplary juice preservation system, in accordance with an embodiment of the present invention; and

FIG. 2 illustrates a flowchart diagram of an exemplary juice preservation method, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

The present invention will now be described in detail with reference to embodiments thereof as illustrated in the accompanying drawings.

There are various types of food and beverage preservations systems that may be provided by preferred embodiments of the present invention. In one embodiment of the present invention, a juice preservation system and method cryogenically freezes freshly processed juice from a liquid state into a plurality of substantially solid, frozen beads. In this solid, frozen state, the juice can be more efficiently stored for extended durations without losing nutritional benefits. The extended shelf life of the solid beads of juice are also more efficient for shipping, mixing with beverages, and marketing.

The juice preservation system and method does not utilize stabilizers or viscosifying agents to modify or enhance the juice. In some embodiments, only organic fruits and vegetables are used, having about 90% juice and 10% vitamins and minerals. The present system and method is efficacious for immediately freezing the juice, in about 3-10 seconds after extraction from the fruit or vegetable to retain the maximum amount of vitamins and nutritional benefits.

In some embodiments, the juice in the liquid state, forms a plurality of beads upon contact with the cryogenic liquid. The beads comprise a substantially spherical shape with a large surface area. The large surface area enables the beads to more readily reconstitute into a liquid for consumption. For example, without limitation, mixing in with a liquid or being chewed or sucked directly. The generally spherical shape is also efficient for packing and storage. Furthermore, the spherical shape of the beads is aesthetic and may comprises various colors, depending on the type of juice. In either case, the beads melt back into the liquid state with a substantial amount of the vitamins and nutrients maintained.

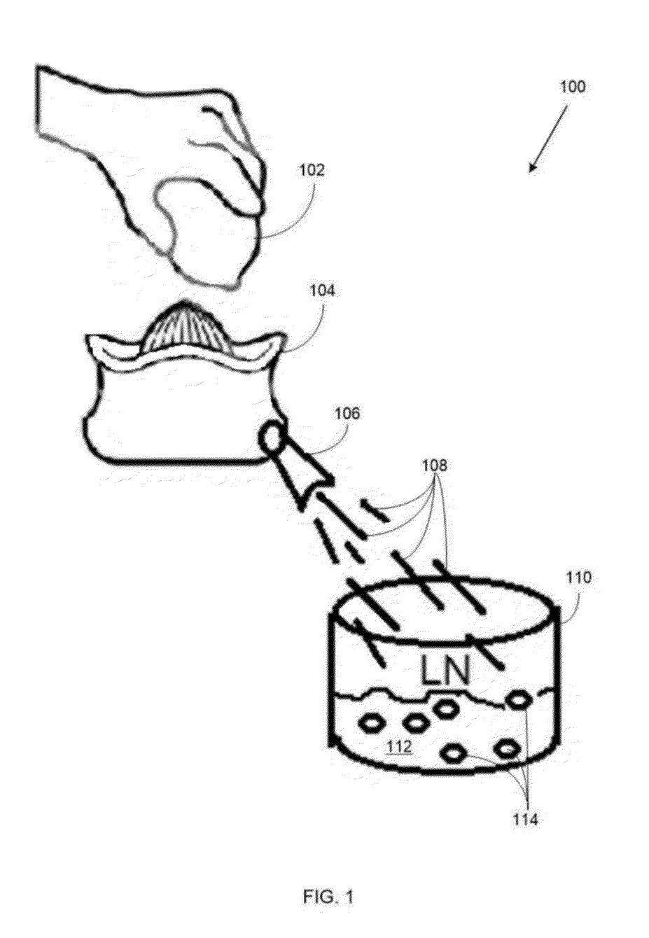

FIG. 1 illustrates a block diagram of an exemplary juice preservation system, in accordance with an embodiment of the present invention. In the present invention, a juice preservation system 100 helps preserve freshly squeezed juice by immediately freezing a juice 108 before the degradation of the cells, vitamins, and nutrients begins. This immediate freezing occurs in a cryogenic liquid 112, such as liquid nitrogen. In some embodiments, the cryogenic liquid may comprise, but not limited to, liquid oxygen, liquid helium, liquid neon, liquid hydrogen, and liquid carbon dioxide. In many embodiments, liquid nitrogen is preferred from a cost and safety aspect. It is believed that liquid nitrogen may be ten times less expensive than some cryogenic liquids. It is believed that inhalation or contact with carbon dioxide gas from the liquid carbon dioxide is hazardous. The cryogenic liquid freezes the freshly processed juice from a liquid state into a plurality of substantially solid, frozen beads 114. The beads may take a generally spherical shape that is efficient for packaging, melting during consumption due to a large surface area, and decorative embellishments. However, the chief advantage of taking the juice from a liquid state to a solid, frozen state, the juice can be more efficiently stored for extended durations without losing nutritional benefits. The extended shelf life of the solid beads of juice are also more efficient for shipping, mixing with beverages, and marketing. The juice may include, without limitation, orange juice, apple juice, grape juice, and carrot juice.

Those skilled in the art will recognize that juice is naturally contained in fruits, vegetables, and meats. The juice may be prepared by mechanically squeezing or macerating the flesh of a fruit or vegetable 102, generally without the application of heat or solvents. The juice contains the optimal amount of vitamins and nutrients when initially separated from the fruit or vegetable. However, after a duration, the cells begin cracking and oxidation starts degrading the vitamins and nutrients. Additionally, vitamins may be added while still maintaining the organic, all-natural state of the juice.

In some embodiments, the system may include a juice processor 104 for processing the flesh from a fruit or vegetable into a juice in a liquid state. The juice processor may include, without limitation, a juicer, a juice press, and a centrifugal juicer, a masticating juicer, a triturating juicer, and generally, any a tool for separating juice from fruits, herbs, leafy greens and other types of fruits and vegetables from a pulp. In some embodiments, an all-natural additive may be added to the juice in the liquid state. The additive may include, without limitation, vitamins, nutrients, anti-oxidants, and the like. The present invention does not add stabilizers, viscosifying agents, preservatives, or other non-natural compositions to the juice. In some embodiments, for fresh “raw juices”, a hydride (H) donor antioxidant, such as, but not limited to, MegaH™ aka Megah™”, or crystal energy may be added to help slow an oxidation process.

In some embodiments, the juice processor may include a discharge portion 106 configured to carry the juice from the juice processor to a liquid cryogenic container 110 that contains the liquid cryogenic. The discharge portion may include a tube that extends out from the juice processor. The tube may have a length that does not allow the liquid state of the juice to freeze prior to contacting the cryogenic liquid. In some embodiments, the duration between the moment that the juice is processed to the moment of engagement with the cryogenic liquid is about 3-10 seconds. This relatively short duration allows the juice to be frozen in a natural state with minimal degradation in quality. As a non-limiting examples for non-cryogenically frozen juice, juice from a centrifugal juicer must be consumed immediately before serious oxidative damage can progressively damage the nutrients. Juice from a masticating juicer may be refrigerated and stored up to 24 hours while maintaining acceptable nutrient quality. The juice from a twin gear juicer may be stored in a refrigerator for approximately 3 days.

In some embodiments, gravity may cause the juice to discharge from the discharge portion, forming variously sized droplets that drip into the liquid cryogenic container. However, in other embodiments, the juice processor may forcibly discharge the juice by spraying, squirting, and pouring the juice into the liquid cryogenic container. The cryogenic liquid may be contained in a cryogenic liquid container. In one embodiment, the container may include a tub having dimensions of 36″ wide and 24″ deep. However, any variable sized dimensions may be used, whereby trial and error minimizes the clumping and other undesirable effects of the beads.

Those skilled in the art will recognize that the rate of dripping, and the pressure used to discharge the juice is determinative of the size of the beads formed in the cryogenic liquid. In one embodiment, the juice may be dripped out of a bottle, a shower head, a paint sprayer, and many various devices with small holes directly into the liquid nitrogen. The juice may then form small, and/or medium, and/or large juice beads depending on how large or small the hole in the discharge portion is, and what the pressure is that is forcing out the juice. In many embodiments, a preferred diameter for the hole may be between and ⅛ and ¼ of an inch in diameter. Smaller may melt faster and larger may not melt as fast for consumer satisfaction. Freezing the juice prevents breakdown of the enzymes, amino acids, and keeps the product from degrading. The shelf life of the juice may also be prolonged.

In some embodiments, the juice in the liquid state freezes immediately into a plurality of beads upon contact with the cryogenic liquid. The rate of discharge may be adjusted to minimize clumping and agglomeration by the beads. However, because there are no non-natural additives in the juice, clumping may be minimized. In some embodiments, the cryogenic liquid may include liquid nitrogen, which is known in the art to safely freeze food and beverage products. Those skilled in the art will recognize that liquid nitrogen is nitrogen in a liquid state at an extremely low temperature. Liquid nitrogen may be produced industrially by fractional distillation of liquid air. The liquid nitrogen has a generally cryogenic freezing temperature of about, −196° Celsius; 77 Kelvin; −321° Fahrenheit. Additionally, liquid nitrogen is often referred to by the abbreviation, LN2 or “LIN” or “LN” and has the UN number 1977. Liquid nitrogen is a diatomic liquid meaning the diatomic character of the covalent N bonding in N2 gas is retained even after liquification.

In some embodiments, the juice preservation system may only utilize organic fruits or vegetables. The organic fruits or vegetables contain minimal pesticides and artificial additives that may disrupt or degrade the freezing process. Ideally, the system does not utilize stabilizers or viscosifying agents to modify or enhance the juice. In some embodiments, only organic fruits and vegetables are used, having about 90% juice and 10% vitamins and minerals. However in other embodiments, 100 juice with no external additives may be used. The present system and method is efficacious for immediately freezing the juice, in about 3-10 seconds after extraction from the fruit or vegetable to retain the maximum amount of vitamins and nutritional benefits.

In some embodiments, the juice in the liquid state, forms a plurality of beads upon contact with the cryogenic liquid. The beads comprise a substantially spherical shape with a large surface area. The large surface area enables the beads to more readily reconstitute into a liquid for consumption. For example, without limitation, mixing in with a liquid or being chewed or sucked directly. The generally spherical shape is also efficient for packing and storage. Furthermore, the spherical shape of the beads is aesthetic and may comprises various colors, depending on the type of juice. In either case, the beads melt back into the liquid state with a substantial amount of the vitamins and nutrients maintained. In another non-limiting example, the beads may be used for baking or cooking if you need fresh juice or in alcoholic beverages.

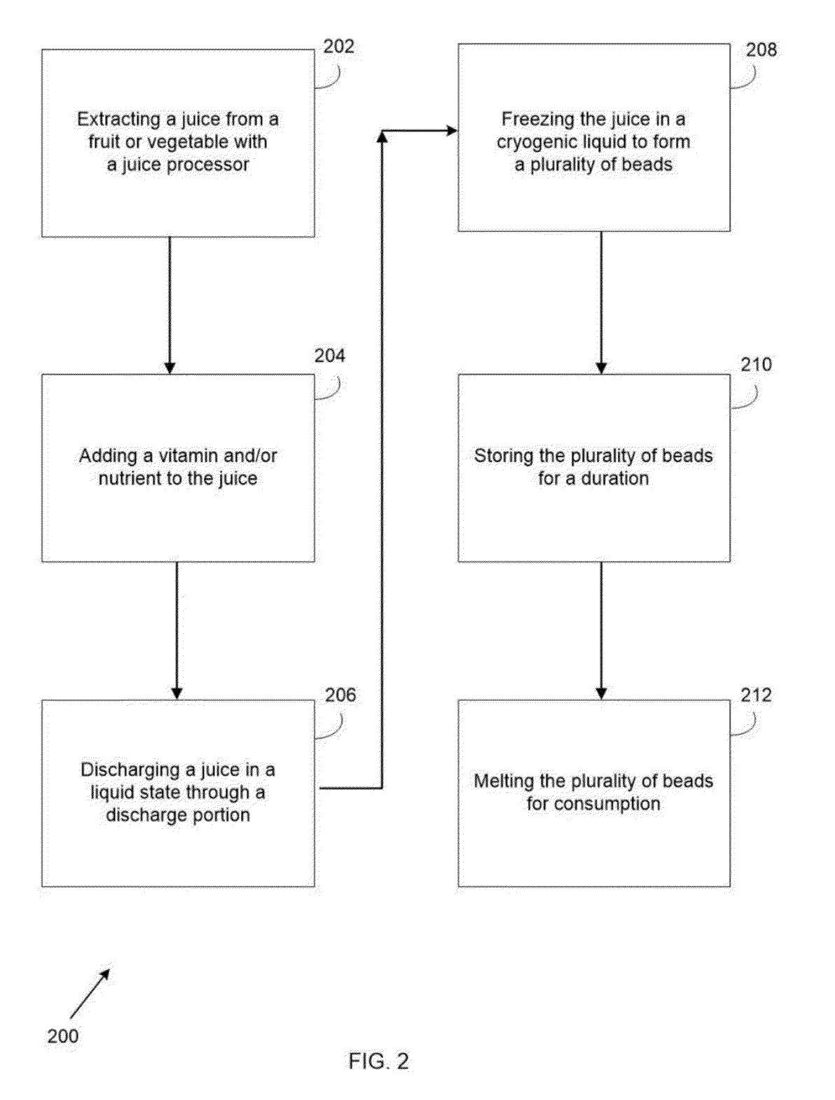

FIG. 2 illustrates a flowchart diagram of an exemplary juice preservation method 200, in accordance with an embodiment of the present invention. In the present invention, the method 200 may include an initial Step 202 of extracting a juice from a fruit or vegetable with a juice processor. The juice processor processes the flesh from a fruit or vegetable into a juice in a liquid state. The juice processor may include a tool for separating juice from fruits, herbs, leafy greens and other types of fruits and vegetables from a pulp.

A Step 204 may include adding a vitamin and/or nutrient to the juice. In some embodiments, an all-natural additive may be added to the juice in the liquid state. The additive may include, without limitation, Vitamin C, Vitamin B, Vitamin A, Iron, Protein, and antioxidants. However, no stabilizers, viscosifying agents, or preservatives are added. The juice is generally processed from an organic fruit or vegetable. In some embodiments, a Step 206 may include discharging a juice in a liquid state through a discharge portion. Gravity may cause the juice to discharge from the discharge portion, forming variously sized droplets that drip into the liquid cryogenic container. However, in other embodiments, the juice processor may forcibly discharge the juice by spraying, squirting, and pouring the juice into the liquid cryogenic container. The rate of discharge, the size of the holes in the discharge portion, and the length of the discharge portion are determinative of the size of beads formed.

A Step 208 comprises freezing the juice in a cryogenic liquid to form a plurality of beads. The beads comprise a substantially spherical shape with a large surface area. The large surface area enables the beads to more readily reconstitute into a liquid for consumption. A Step 210 may include storing the plurality of beads for a duration. The shelf life is extended, since the cryogenic freezing inhibits degradation of the juice. A final Step 212 comprises melting the plurality of beads for consumption. The beads may be consumed by mixing in a drink or chewing and sucking. In essence, the beads are mini flavored ice cubes.

In one alternative embodiment, gravy from meat may be cryogenically frozen, and then added to meat and vegetables in an oven. In another alternative embodiment, the juice in the liquid state may be dripped from a high platform into a super cold room, whereby the juice forms solid forms during the fall. In yet another alternative embodiment, the cryogenic liquid container mates with the juice processor with a barrier there between. In this manner, the barrier can be removed to dump the juice into the cryogenic liquid. This allows for a faster flash freeze effect.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied. Thus, the present invention is not limited to any particular tangible means of implementation.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing means for and/or steps described that the applications designer will selectively decide, depending upon the practical considerations of the particular implementation, to carry out and/or locate within the jurisdiction of the USA. For example, any of the foregoing described method steps and/or system components which may be performed remotely over a network (e.g., without limitation, a remotely located server) may be performed and/or located outside of the jurisdiction of the USA while the remaining method steps and/or system components (e.g., without limitation, a locally located client) of the forgoing embodiments are typically required to be located/performed in the USA for practical considerations. In client-server architectures, a remotely located server typically generates and transmits required information to a US based client, for use according to the teachings of the present invention. Depending upon the needs of the particular application, it will be readily apparent to those skilled in the art, in light of the teachings of the present invention, which aspects of the present invention can or should be located locally and which can or should be located remotely. Thus, for any claims construction of the following claim limitations that are construed under 35 USC §112 (6) it is intended that the corresponding means for and/or steps for carrying out the claimed function are the ones that are locally implemented within the jurisdiction of the USA, while the remaining aspect(s) performed or located remotely outside the USA are not intended to be construed under 35 USC §112 (6).

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC §112 (1), all claims must be supported by sufficient disclosure in the present patent specification, and any material known to those skilled in the art need not be explicitly disclosed. However, 35 USC §112 (6) requires that structures corresponding to functional limitations interpreted under 35 USC §112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC §112 (6) when such corresponding structures are not explicitly disclosed in the foregoing patent specification. Therefore, for any invention element(s)/structure(s) corresponding to functional claim limitation(s), in the below claims interpreted under 35 USC §112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC §112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC §112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC §112 (6). Applicant(s) note that all the identified documents above which are incorporated by reference to satisfy 35 USC §112 (6) necessarily have a filing and/or publication date prior to that of the instant application, and thus are valid prior documents to incorporated by reference in the instant application.

Having fully described at least one embodiment of the present invention, other equivalent or alternative methods of implementing a system and method for cryogenically freezing juice in a short duration according to the present invention will be apparent to those skilled in the art. Various aspects of the invention have been described above by way of illustration, and the specific embodiments disclosed are not intended to limit the invention to the particular forms disclosed. The particular implementation of the system and method for cryogenically freezing juice in a short duration may vary depending upon the particular context or application. By way of example, and not limitation, the system and method for cryogenically freezing juice in a short duration described in the foregoing were principally directed to processing juices and immediately cryogenically freezing the juice into solid frozen beads for extended shelf life implementations; however, similar techniques may instead be applied to mass production of the frozen juice beads by using a large room where the liquid juice is dropped from a high elevation and freezes during the fall, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A method comprising the steps of:
extracting a juice from an editable food material using a juice processor;
dispensing the extracted juice into a container having a volume, the volume being at a cryogenic temperature wherein the dispensed extracted juice generally forms a plurality of beads at the cryogenic temperature; and
storing the plurality of beads, the stored plurality of beads having a longer shelf life than non-frozen extracted juice and nutritional degradation is mitigated.

2. The method as recited in claim 1, further comprising the step of adding a natural additive to the extracted juice.

3. The method as recited in claim 1, further comprising the step of discharging the extracted juice through a discharge portion of the juice processor.

4. The method as recited in claim 1, further comprising the step of melting a portion of the stored plurality of beads for consumption wherein a substantial amount of vitamins and nutrients are maintained.

5. The method as recited in claim 1, in which the volume comprises a cryogenic liquid.

6. The method as recited in claim 5, in which the cryogenic liquid comprises liquid nitrogen.

7. The method as recited in claim 1, in which the plurality of beads comprise generally spherical shapes.

8. The method as recited in claim 3, in which the discharge portion dispenses the extracted juice though a plurality of holes having diameters being substantially in a range between ⅛ and ¼ of an inch.

9. The method as recited in claim 1, in which the extracted juice is dispensed into the volume within a range of about 3-10 seconds after extraction.

10. The method as recited in claim 3, in which the juice processor exerts a force on the extracted juice during said discharging.

11. The method as recited in claim 3, in which the discharge portion is in engagement with the volume.

12. The method as recited in claim 2, in which the natural additive comprises an antioxidant.

13. The method as recited in claim 2, in which the natural additive comprises a vitamin.

14. The method as recited in claim 2, in which the natural additive comprises a nutrient.

15. The method as recited in claim 1, in which the editable food material comprises a fruit or a vegetable.

16. A method comprising:
steps for extracting a juice from an editable food material;
steps for dispensing the extracted juice into a container having a volume, the volume being at a cryogenic temperature wherein the dispensed extracted juice generally forms a plurality of beads at the cryogenic temperature; and
steps for storing the plurality of beads, the stored plurality of beads having a longer shelf life than non-frozen extracted juice and nutritional degradation is mitigated.

17. The method as recited in claim 16, further comprising steps for adding a natural additive to the extracted juice.

18. The method as recited in claim 16, further comprising steps for discharging the extracted juice.

19. The method as recited in claim 16, further comprising steps for of melting a portion of the stored plurality of beads for consumption wherein a substantial amount of vitamins and nutrients are maintained.

20. A system comprising:
a juice processor being configured for extracting a juice from a fruit or a vegetable, said juice processor comprising a discharge portion being configured for discharging the extracted juice, said discharge portion comprising a plurality of holes having diameters being substantially in a range between ⅛ and ¼ of an inch, said juice processor being further configured for exerting a force on the extracted juice during the discharging through said discharge portion, wherein the extracted juice is discharged within a range of about 3-10 seconds after extraction; and
a container having a volume, said volume being configured for retaining a quantity of liquid nitrogen at a cryogenic temperature and for receiving the discharged extracted juice, wherein the dispensed extracted juice generally forms a plurality of beads at the cryogenic temperature, the plurality of beads comprise generally spherical shapes, wherein stored beads have a longer shelf life than non-frozen extracted juice and nutritional degradation is mitigated.
